(19) United States
(12) Patent Application Publication
(10) Pub. No.: US 2026/0088659 A1
(43) Pub. Date: Mar. 26, 2026

(54) SYSTEM LOAD LINE CHARACTERIZATION FOR STABILITY AND POWER NEGOTIATION

(71) Applicant: Apple Inc., Cupertino, CA (US)

(72) Inventors: Ali Abdolkhani, Auckland (NZ); Stephen C Terry, San Jose, CA (US); Jerald Polestico Guillermo, Auckland (NZ); Wynand Malan, Auckland (NZ); Alin I Gherghescu, Campbell, CA (US)

(21) Appl. No.: 19/280,418

(22) Filed: Jul. 25, 2025

Related U.S. Application Data
(60) Provisional application No. 63/699,390, filed on Sep. 26, 2024.

(51) Int. Cl. H02J 50/12

(52) U.S. Cl. CPC H02J 50/12

(57) ABSTRACT

A wireless power transmitter can include an inverter that generates an AC voltage; a wireless power transmitting coil that receives the AC voltage from the inverter, the wireless power transmitting coil being couplable to a wireless power receiving coil of a wireless power receiver; and controller circuitry that operates the inverter to deliver power wirelessly, using the wireless power transmitting coil, to the wireless power receiver by: characterizing a load line corresponding to the wireless power transmitter, the wireless power receiver, and a relative position between the wireless power transmitter and the wireless power receiver using a plurality of wireless power transfer system parameters determined by in-circuit measurements; identifying a stability boundary associated with the load line; and operating the wireless power transmitter at a power level that causes the wireless power transmitter to remain on a stable side of the stability boundary for the characterized load line.

### BACKGROUND

Wireless power transfer is used in various electronic devices. For example, smart phones, tablet computers, smart watches, wireless earphones, styluses, etc. may employ wireless power transfer to facilitate charging of batteries within the devices. In some applications, estimation, calculation, or determination of coupling factor and/or other electrical, magnetic, and electromagnetic properties of the wireless power transfer circuit may be used to characterize and control the wireless power transfer link.

### SUMMARY

A wireless power transmitter can include an inverter that generates an AC voltage when receiving an input voltage; a wireless power transmitting coil that receives the AC voltage from the inverter, the wireless power transmitting coil being couplable to a wireless power receiving coil of a wireless power receiver; and controller circuitry that operates the inverter to deliver power wirelessly, using the wireless power transmitting coil, to the wireless power receiver by: characterizing a load line corresponding to the wireless power transmitter, the wireless power receiver, and a relative position between the wireless power transmitter and the wireless power receiver using a plurality of wireless power transfer system parameters determined by in-circuit measurements; identifying a stability boundary associated with the load line; and operating the wireless power transmitter at a power level that causes the wireless power transmitter to remain on a stable side of the stability boundary for the characterized load line.

The plurality of wireless power transfer system parameters determined by in-circuit measurements can be determined by combining one or more circuit parameters of the wireless power transmitter measured with the wireless power receiving coil effectively short circuited, including one or more circuit parameters measured with a first transmitter tuning capacitance and one or more circuit parameters measured with a second transmitter tuning capacitance, with one or more circuit parameters of the wireless power transmitter measured with the wireless power receiving coil open circuited, including one or more circuit parameters measured with a first transmitter tuning capacitance and one or more circuit parameters measured with a second transmitter tuning capacitance.

Identifying a stability boundary associated with the load line can include identifying a peak power level of the one or more power levels and setting a target power level corresponding to the peak power level. The target power level can be the peak power level minus a margin. The margin can be selected from the group consisting of: 5%, 10%, 15%, or 20% less the peak power level. The margin can be selected from the group consisting of: 1 W, 2 W, 3 W, or 5 W less the peak power level.

Identifying a stability boundary associated with the load line can include identifying a boundary resistance associated with the target power level. Operating the wireless power transmitter at a power level that causes the wireless power transmitter to remain on a stable side of the stability boundary for the characterized load line can include determining a load resistance applied to the wireless power receiver; comparing the determined load resistance to the identified boundary resistance; and responsive to the comparison indicating that the load resistance is not on the stable side of the stability boundary, reducing the target power level. The stable side of the stability boundary can be determined at least in part by whether a load on the wireless power receiver is a buck-type converter or a boost-type converter.

The load on the wireless power receiver can be a battery charger.

A method of operating a wireless power transmitter in a wireless power transfer system comprising the wireless power transmitter and a wireless power receiver coupled to the wireless power transmitter can be performed by control circuitry of the wireless power transmitter and can include characterizing a load line corresponding to the wireless power transmitter, the wireless power receiver, and a relative position between the wireless power transmitter and the wireless power receiver using a plurality of wireless power transfer system parameters determined by in-circuit measurements; identifying a stability boundary associated with the load line; and operating the wireless power transmitter at a power level that causes the wireless power transmitter to remain on a stable side of the stability boundary for the characterized load line.

The plurality of wireless power transfer system parameters determined by in-circuit measurements can be determined by combining one or more circuit parameters of the wireless power transmitter measured with the wireless power receiving coil effectively short circuited, including one or more circuit parameters measured with a first transmitter tuning capacitance and one or more circuit parameters measured with a second transmitter tuning capacitance, with one or more circuit parameters of the wireless power transmitter measured with the wireless power receiving coil open circuited, including one or more circuit parameters measured with a first transmitter tuning capacitance and one or more circuit parameters measured with a second transmitter tuning capacitance.

Identifying a stability boundary associated with the load line can include identifying a peak power level of the one or more power levels and setting a target power level corresponding to the peak power level. The target power level can be the peak power level minus a margin. The margin can be selected from the group consisting of: 5%, 10%, 15%, or 20% less the peak power level. The margin can be selected from the group consisting of: 1 W, 2 W, 3 W, or 5 W less the peak power level.

Identifying a stability boundary associated with the load line can include identifying a boundary resistance associated with the target power level. Operating the wireless power transmitter at a power level that causes the wireless power transmitter to remain on a stable side of the stability boundary for the characterized load line can include determining a load resistance applied to the wireless power receiver; comparing the determined load resistance to the identified boundary resistance; and responsive to the comparison indicating that the load resistance is not on the stable side of the stability boundary, reducing the target power level. The stable side of the stability boundary can be determined at least in part by whether a load on the wireless power receiver is a buck-type converter or a boost-type converter.

A wireless power transmitter controller that operates an inverter of the wireless power transmitter to deliver power wirelessly, using a wireless power transmitting coil of the wireless power transmitter, to a wireless power receiver having a wireless power receiving coil couplable to the wireless power transmitting coil, can include circuitry that: characterizes a load line corresponding to the wireless power transmitter, the wireless power receiver, and a relative position between the wireless power transmitter and the wireless power receiver using a plurality of wireless power transfer system parameters determined by in-circuit measurements; identifying a stability boundary associated with the load line further including identifying a peak power level of the one or more power levels; setting a target power level corresponding to the peak power level; and identifying a boundary resistance associated with the target power level; and operating the wireless power transmitter at a power level that causes the wireless power transmitter to remain on a stable side of the stability boundary for the characterized load line further including determining a load resistance applied to the wireless power receiver; comparing the determined load resistance to the identified boundary resistance; and responsive to the comparison indicating that the load resistance is not on the stable side of the stability boundary, reducing the target power level.

### BRIEF DESCRIPTION OF THE DRAWINGS

FIG. 1 illustrates a simplified block diagram of a wireless power transfer system.

FIG. 2 illustrates a simplified schematic diagram of a wireless power transfer system.

FIG. 3 illustrates a flowchart of coupling coefficient estimation technique.

FIG. 4 illustrates a timing sequence for a coupling coefficient estimation technique.

FIG. 5 illustrates a simplified block diagram of a wireless power transfer system depicting loads on the wireless power receiver.

FIG. 6 illustrates a simplified block diagram of a wireless power receiver rectifier and buck converter battery charger load.

FIG. 7 illustrates exemplary load line curves for a wireless power transfer system.

FIG. 8 illustrates a flowchart of a stability and power limit determination technique using in-circuit measurements to determine a stable operating power level.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

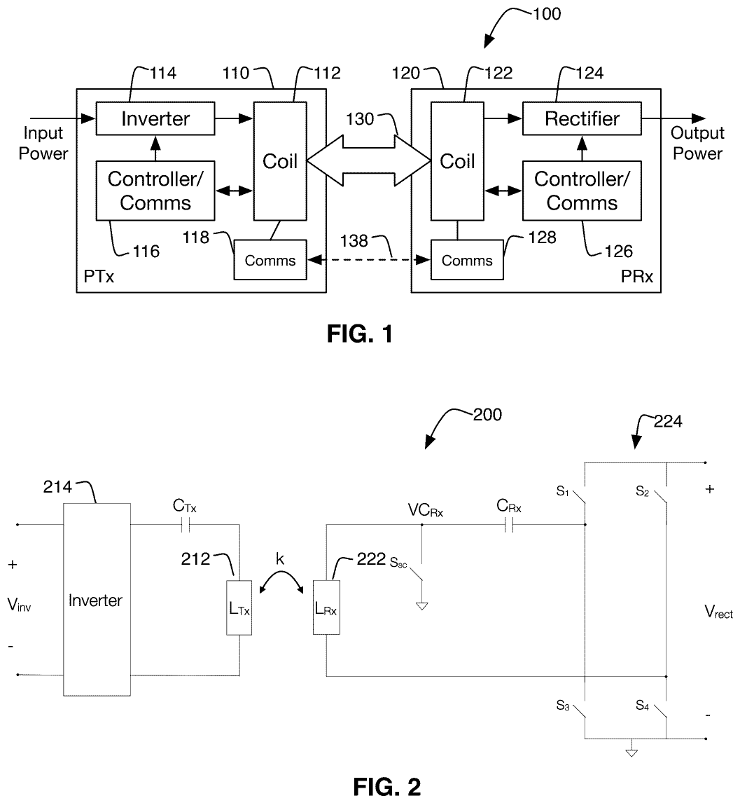

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the receiver, the transmitter coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transmitter coil may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications module 118. In some embodiments, comms module 118 may communicate with a corresponding module tag in the PRx via the power transfer coils. In other embodiments, comms module 118 may communicate with a corresponding module using a separate physical channel 138.

As noted above, wireless power transfer system also includes a wireless power receiver (PRx) 120. Wireless power receiver can include a receiver coil 122 that may be magnetically coupled 130 to the transmitter coil 112. As with transmitter coil 112 discussed above, receiver coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the receiver. This information may be received sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry. PRx device 120 may optionally include other systems and components, such as a communications (“comms”) module 128. In some embodiments, comms module 128 may communicate with a corresponding module in the PTx via the power transfer coils. In other embodiments, comms module 128 may communicate with a corresponding module or tag using a separate physical channel 138.

Numerous variations and enhancements of the above-described wireless power transmission system 100 are possible, and the following teachings are applicable to any of such variations and enhancements.

In wireless power transfer systems, it may be useful to know a magnetic coupling coefficient (also called “coupling coefficient” and sometimes denoted “k”), which is indicative of a degree of magnetic coupling between a PTx device and a PRx device. The coupling coefficient can be used for various purposes in a wireless power transfer system, such as providing an indication of a degree of alignment between a PTx device and a PRx device, indication of the presence of a foreign object in proximity to the wireless power transfer devices, etc. Thus, wireless power transfer devices may be provided with mechanisms for calculating, estimating, or determining such coupling coefficient, which can be understood with reference to the simplified schematic of a wireless power transfer system depicted in FIG. 2.

FIG. 2 depicts a simplified schematic of a wireless power transfer system 200. The PTx device is depicted on the left side of the figure, in which an inverter 214, generally corresponding to inverter 114 discussed above with reference to FIG. 1 can receive an input voltage Vinv. Inverter 214 can produce an AC output voltage that can be provided to a wireless power transfer coil 212 (corresponding to coil 112 discussed above and represented in FIG. 2 as an inductance LTx). Inverter 214 may be coupled to wireless power transfer coil 212 by a tuning capacitance represented in the schematic by capacitor CTx. In some embodiments a selectable tuning capacitance may be provided to allow the circuit to be tuned for different operating conditions.

With further reference to FIG. 2, wireless power transfer coil 212 can be magnetically or inductively coupled to a wireless power transfer coil 222 (corresponding to coil 122 discussed above and represented in FIG. 2 as an inductance LRx), when the devices are in physical proximity of one another. As a result of this magnetic or inductive coupling, represented by coupling coefficient k, an AC voltage/current in wireless power transfer coil 212 can induce a corresponding AC voltage/current in wireless power transfer coil 222. This AC voltage/current can be coupled to a rectifier 224 by a tuning capacitance represented in the schematic by capacitor CRx. In some embodiments a selectable tuning capacitance may be provided to allow the circuit to be tuned for different operating conditions. In FIG. 2, rectifier 224 is depicted as a full bridge rectifier comprised of a plurality of switching devices S1-S4. Rectifier 224 can produce a DC output voltage Vrect, which can be used for various purposes within the PRx device, such as charging a battery, powering receiver device systems, etc.

As noted above, it can be useful for various purposes to estimate coupling coefficient k. In some prior art wireless power transfer systems, an estimated coupling coefficient value kₑₛₜ has been determined in accordance with the formula:

$${k}_{est} = \frac{{C}_{0} \cdot {V}_{rect}}{{V}_{inv} + V C T {X}_{pp}} + {C}_{1}$$

where V_{rect} is the rectified voltage measured on the receiver side during startup; Vinv is the inverter input voltage on the transmitter side; VCTXₚₚ is the peak-to-peak voltage measured across the transmitter tuning capacitor C_{Tx}, and C₀ and C₁ are fit coefficients obtained for a given range of coupling between a given PTx and PRx device. While the above formula can provide a usable estimate of coupling coefficient, it has certain limitations and can be improved upon.

It is desirable to determine coupling coefficient k while allowing for simplified measurements that can be performed in-field (i.e., after manufacture) without extensive pre-manufacture testing, etc. Such techniques can be based on measurements made with the receiver side wireless power transfer coil 222 (represented by inductance LRx) short circuited vs. open circuited. More specifically, the magnetic coupling coefficient k between two magnetically coupled coils can be given by:

$$k = \sqrt{1 - \frac{{L}_{Tx , sc}}{{L}_{Tx , oc}}}$$

where L_{Tx,sc} is the inductance of the Tx coil 212 measured with a short-circuited Rx coil 222, and L_{Tx,oc} is the measured inductance of the Tx coil 212 measured with an open-circuited Rx coil 222. The short circuit inductance L_{Tx,sc} and open circuit inductance L_{Tx,oc}, respectively can be given by:

$$\{ \begin{matrix}{L}_{Tx , sc} = \frac{1}{{( 2 π {f}_{s c} )}^{2} {C}_{Tx}} \\ {L}_{Tx , oc} = \frac{1}{{( 2 π {f}_{oc} )}^{2} {C}_{Tx}}\end{matrix}$$

where f_{sc} is the resonant frequency measured with the Rx coil short circuited, f_{oc} is the resonant frequency with the Rx coil open circuited, and C_{Tx} is the transmitter side tuning capacitance. Combining with the coupling coefficient determination equation above gives:

$$k = \sqrt{1 - \frac{\frac{1}{{( 2 π {f}_{sc} )}^{2} {C}_{Tx}}}{\frac{1}{{( 2 π {f}_{oc} )}^{2} {C}_{Tx}}}} = \sqrt{1 - \frac{{( {f}_{oc} )}^{2}}{{( {f}_{sc} )}^{2}}}$$

Thus, the coupling coefficient can be determined or calculated based on two transmitter side, in circuit measurements of resonant frequency, one made with the receiver side wireless power transfer coil short circuited and one with the receiver side wireless power transfer coil open circuited.

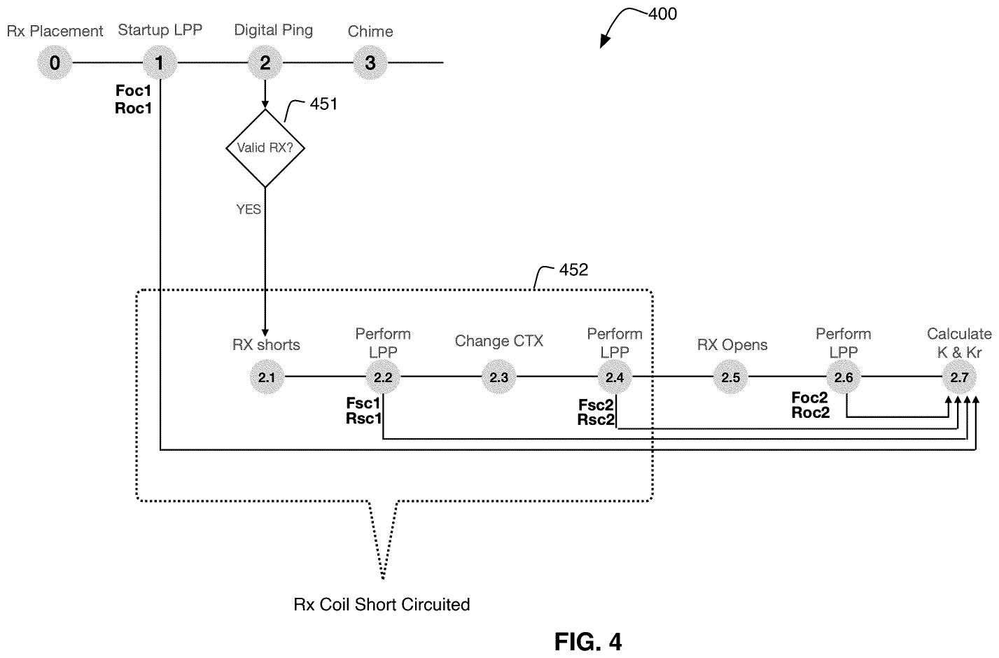

Such techniques for coupling coefficient determination are based on being able to measure circuit parameters including or corresponding to the inductance of the transmitter side wireless power transfer coil during operating conditions in which the receiver side wireless power transfer coil is open circuited and short circuited, examples of which are described in greater detail below. In general, such measurements can be performed during what is sometimes called a “low power ping” or “LPP” phase of the wireless power transfer startup sequence, described in greater detail below with respect to FIG. 4.

As illustrated in FIG. 2, there are at least two ways that the receiver side wireless power transfer coil 222 can be effectively short circuited. As used herein, “effectively short circuited” means that either the coil or the resonant tank including the coil and any tuning capacitance is short circuited, as described in greater detail below. One straightforward way is to provide an additional switch S_{sc} specifically for the purpose of short circuiting the receiver side wireless power transfer coil 222, i.e., connecting one terminal of the coil to ground. The other terminal may be shorted/connected to ground using rectifier switch S₄. An advantage of such a configuration is that it short circuits the coil entirely, with no other components included in the circuit. A potential disadvantage of such a configuration, for at least some embodiments, is that it requires an additional switching device on the receiver side. In any case, such a circuit configuration can rely on the formulae above for coupling coefficient determination.

As an alternative, another way that the receiver side wireless power transfer coil 222 can be effectively short circuited is by closing rectifier switches S₃ and S₄. If there is no tuning capacitance C_{Rx} (which may be the case in at least some embodiments), then the coil is effectively short circuited, just as in the S_{sc}/S₄ technique described above. The same is effectively true if the tuning capacitance C_{Rx} is sufficiently large that it is used more like a DC blocking capacitor than a tuning capacitor, which may be the case for at least some PRx device designs. Otherwise, if there is a tuning capacitance C_{Rx} of nominal value (which may be the case in at least some embodiments), then the short circuit is actually of the wireless power transfer coil and tuning capacitance, sometimes collectively described as a resonant tank. Thus, the short circuit is not just of the receiver side wireless power transfer coil, and the coupling coefficient formula described above must be altered to account for the tuning capacitance.

In this alternative, the formulae above may be adjusted to account for the fact that the receiver side tuning capacitance CRx is included in the short circuit. More specifically, the coupling coefficient can be determined by:

$$k = \sqrt{1 - \frac{{( {f}_{oc} )}^{2}}{{( {f}_{sc} )}^{2}}} \sqrt{1 - \frac{1}{{( 2 π {f}_{sc} )}^{2} {C}_{Rx} {L}_{Rx}}}$$

where C_{Rx} is the receiver side tuning capacitance and other variables are as given above.

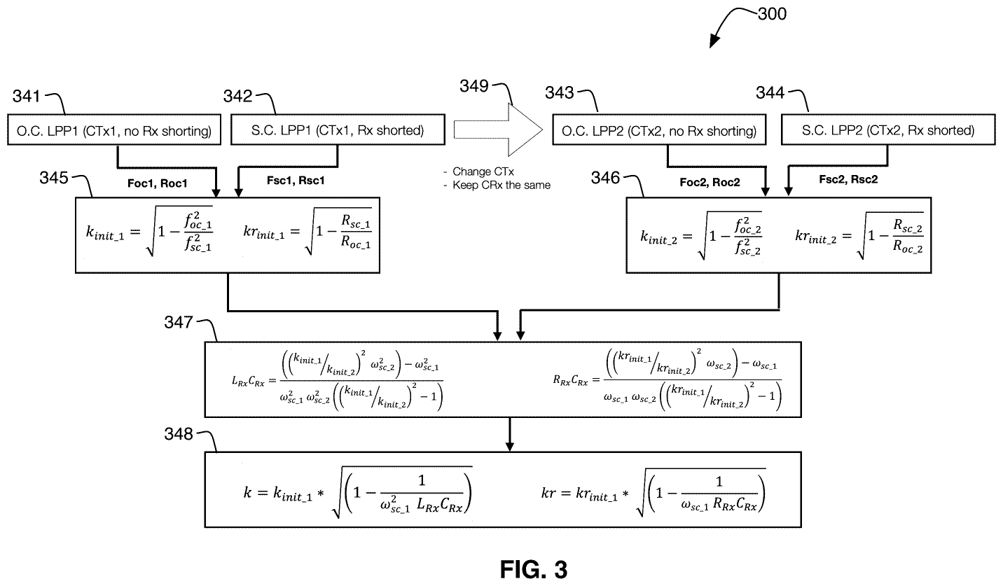

FIG. 3 illustrates a flowchart 300 depicting a coupling coefficient determination technique as described above. The steps of the flow chart can be performed by the controller circuitry of a wireless power transmitter (as was described above) or by any other suitable controller circuitry in the wireless power transfer system. The illustrated flow chart depicts determining both a magnetic coupling coefficient k and a resistive coupling coefficient kr for a wireless power transfer system that includes a switchable transmitter side tuning capacitance C_{Tx}. That is, the tuning capacitance C_{Tx} may take on two (or more values), e.g., C_{Tx1} and C_{Tx2}. In some applications, the coupling coefficient k may be an indicator used to select a tuning capacitance value. Additionally, the resistive coupling coefficient kr may be used to improve various aspects of operating or controlling a wireless power transfer system, such as improved foreign object detection. In any case, flowchart 300 depicts four separate measurement blocks 341-344. In block 341, open circuit measurements using a first transmitter side tuning capacitance value C_{Tx1} may be performed. In block 342, short circuit measurements using the first transmitter side tuning capacitance value C_{Tx1} may be performed. In block 343, open circuit measurements using a second transmitter side tuning capacitance value C_{Tx2} may be performed. In block 344, short circuit measurements using the second transmitter side tuning capacitance value C_{Tx2} may be performed. Depicted between blocks 342 and 343 is a transition arrow 349 corresponding to the change in transmitter side tuning capacitance, e.g., from C_{Tx1} to C_{Tx2}. However, the order described above and timing of the C_{Tx} transition is not critical, and the measurements may be performed in any order desired. One example of such a sequence is described in greater detail below with respect to FIG. 4.

In any case, the first measurement block 341 can produce two values: the open circuit resonant frequency, depicted as Foc1, and the open circuit resistance value Roc1 (which can be used to determine the resistive coupling coefficient, as described in greater detail below). Likewise, the second measurement block 342 can produce two additional values: the short circuit resonant frequency Fsc1, and the short circuit resistance value Rsc1 (which can be used to determine the resistive coupling coefficient, as described in greater detail below). If the resistive coupling coefficient kr is not required for a particular application, the resistance measurements may be omitted. In any case, the measurements from measurement blocks 341 and 342 can be fed to an initial computation block 345. In initial computation block 345, an initial (magnetic) coupling coefficient can be computed as described above, or, more specifically, using the formula:

$${k}_{init \_ 1} = \sqrt{1 - \frac{{( {f}_{oc \_ 1} )}^{2}}{{( {f}_{sc \_ 1} )}^{2}}}$$

where k_{init_1} is the initial coupling coefficient corresponding to the first transmitter side tuning capacitance value, f_{oc_1} corresponds to the open circuit resonant frequency measurement Foc1, and f_{sc_1} corresponds to the short circuit resonant frequency measurement Fsc1. Likewise, if the resistive coupling coefficient is required for a given application, the initial resistive coupling coefficient can be computed using a similar formula:

$${kr}_{init \_ 1} = \sqrt{1 - \frac{{R}_{sc \_ 1}}{{R}_{oc \_ 1}}}$$

where kr_{init_1} is the initial resistive coupling coefficient corresponding to the first transmitter side tuning capacitance value, R_{sc_1} corresponds to the short circuit resistance measurement Rsc1, and R_{oc_1} corresponds to the open circuit resistance measurement Rsc1.

The above-described computations of initial computation block 345 give magnetic and resistive coupling coefficient values for cases in which it is not necessary to compensate for the transmitter side tuning capacitance, such as when the receiver side wireless power transfer coil can be short circuited or when the transmitter side tuning capacitance is sufficiently large that its value can be neglected. For other cases, the values determined in initial computation block can be fed into a further computation block 347 described in greater detail below to compensate for the tuning capacitance.

In cases with adjustable transmitter side tuning capacitance, this capacitance value C_{Tx} can be switched, and measurement blocks 343 and 344 can be performed. The third measurement block 343 can produce two values: the open circuit resonant frequency, depicted as Foc2, and the open circuit resistance value Roc2 corresponding to the second transmitter side tuning capacitance value. Likewise, the fourth measurement block 344 can produce two additional values: the short circuit resonant frequency Fsc2, and the short circuit resistance value Rsc2, both corresponding to the second transmitter side tuning capacitance value. If the resistive coupling coefficient kr is not required for a particular application, the resistance measurements may be omitted. In any case, the measurements from measurement blocks 343 and 344 can be fed to an initial computation block 346, which can generally correspond to initial computation block 345, described above. In initial computation block 346, an initial (magnetic) coupling coefficient (corresponding to the second transmitter side tuning capacitance value) can be computed as described above, or, more specifically, using the formula:

$${k}_{init \_ 2} = \sqrt{1 - \frac{{( {f}_{oc \_ 2} )}^{2}}{{( {f}_{sc \_ 2} )}^{2}}}$$

where k_{init_2} is the initial coupling coefficient corresponding to the second transmitter side tuning capacitance value, f_{oc_2} corresponds to the open circuit resonant frequency measurement Foc2, and f_{sc_2} corresponds to the short circuit resonant frequency measurement Fsc2. Likewise, if the resistive coupling coefficient is required for a given application, the initial resistive coupling coefficient can be computed using a similar formula:

$${kr}_{init \_ 2} = \sqrt{1 - \frac{{R}_{sc \_ 2}}{{R}_{oc \_ 2}}}$$

where kr_{init_2} is the initial resistive coupling coefficient corresponding to the second transmitter side tuning capacitance value, R_{sc_2} corresponds to the short circuit resistance measurement Rsc2, and R_{oc_2} corresponds to the open circuit resistance measurement Rsc2.

The above-described computations of initial computation block 346 give magnetic and resistive coupling coefficient values that can be used to compensate for the transmitter side tuning capacitance, such as when the receiver side wireless power transfer coil cannot be short circuited alone (e.g., when the resonant tank as a whole is short circuited) or when the transmitter side tuning capacitance is not sufficiently large that its value can be neglected. In such cases, the values determined in initial computation block can be fed into a further computation block 347.

Further computation block 347 can be performed to determine the values L_{Rx}C_{Rx} (i.e., the product of the receiver side inductance and capacitance) and R_{Rx}C_{Rx} (i.e., the product of the receiver side resistance and capacitance), which can be used to compensate the initial coupling coefficient values k_{init_1} and kr_{init_1} determined above in initial computation block 345. More specifically the quantity L_{Rx}C_{Rx} can be given by:

$${L}_{Rx} {C}_{Rx} = \frac{( {( {k}_{init \_ 1} / {k}_{init \_ 2} )}^{2} {ω}_{sc \_ 2}^{2} ) - {ω}_{sc \_ 1}^{2}}{{ω}_{sc \_ 1}^{2} {ω}_{sc \_ 2}^{2} ( {( {k}_{init \_ 1} / {k}_{init \_ 2} )}^{2} - 1 )}$$

where k_{init_1} and k_{init_2} are computed as described above with reference to initial computation blocks 345 and 346, ω_{sc_1} and ω_{sc_2} are the angular frequency (radians per second) expressions of the short circuit resonant frequency measurements Fsc1 and Fsc2 (measured in Hertz or cycles per second) as described above, i.e., ω=2πf. Likewise, if required for compensating a resistive coupling factor, the quantity R_{Rx}C_{Rx} can be given by:

$${L}_{Rx} {C}_{Rx} = \frac{( {( {kr}_{init \_ 1} / {kr}_{init \_ 2} )}^{2} {ω}_{sc \_ 2} ) - {ω}_{sc \_ 1}}{{ω}_{sc \_ 1} {ω}_{sc \_ 2} ( {( {kr}_{init \_ 1} / {kr}_{init \_ 2} )}^{2} - 1 )}$$

where kr_{init_1} and kr_{init_2} are computed as described above with reference to initial computation blocks 345 and 346, and the other parameters are as described above.

The compensating parameters L_{Rx}C_{Rx} and R_{Rx}C_{Rx} computed in further computation block 347 can then be provided to compensation block 348 in which the compensated (magnetic) coupling coefficient k can be determined by:

$$k = {k}_{init \_ 1} \sqrt{1 - \frac{1}{{ω}_{sc \_ 1}^{2} {L}_{Rx} {C}_{Rx}}}$$

where all parameters are as described above. Similarly, if a compensated resistive coupling coefficient kr is required, then the compensated resistive coupling coefficient kr can be determined by:

$$k = {kr}_{init \_ 1} \sqrt{1 - \frac{1}{{ω}_{sc \_ 1} {R}_{Rx} {C}_{Rx}}}$$

where all parameters are as described above.

FIG. 4 illustrates a timing sequence 400 for a coupling coefficient estimation technique. Timing sequence 400 corresponds to a wireless power startup or initiation sequence, which can be initiated by a wireless power receiver (Rx) being brought into proximity with a wireless power transmitter (Tx). The startup sequence may be performed according to an industry standard, such as the Qi family of standards promulgated by the Wireless Power Consortium (“WPC”). Alternatively, the startup sequence may be performed according to a non-standard and/or proprietary technique that may be wholly or partially compatible with an industry standard startup sequence. In the illustrated example of FIG. 4, the startup sequence can begin with the Rx being placed in proximity with the Tx, as depicted by block 0. Subsequently, a startup low power ping “LPP” operation can be performed as depicted by block 1. This low power ping can include an initial attempt at wireless power transmission by the wireless power transmitter that can provide the initial open circuit measurements Foc1 and, optionally Roc1 as described above with reference to FIG. 3. These value(s) can be provided to the coupling coefficient calculation block 2.7 described in greater detail below. If the LPP indicates that an object is present in proximity to the wireless power transmitter, then a digital ping may commence, as represented by block 2. This digital ping can include an attempt by the Tx to initiate digital communication with the Rx, for example in-band communication by FSK (frequency shift keying) of the drive signal provided by the inverter to the wireless power transmitting. If the Rx receives to the attempt to initiate digital communication, for example by in-band communication using ASK (amplitude shift keying) of the received wireless power by the rectifier, then the Tx can determine that a valid receiver device is present (block 451). Otherwise, the initiation process can restart at block 0 or 1, though such process is beyond the scope of the present disclosure.

If a digital ping process, such as that described above, results in determining that a valid receiver device is present, then coupling coefficient determination can proceed along the lines discussed above with respect to FIGS. 1-3. More specifically, the Rx can short circuit the receiver side wireless power transfer coil or the resonant tank (block 2.1) to allow for one or more resonant frequency or optional measurements to be made. In some embodiments, the Rx can short the coil and/or tank automatically as a matter of course at a predetermined time or sequence in the digital ping process. In some embodiments, the Rx can short the coil and/or tank responsive to an instruction or communication received from the Tx. In either case, the Rx can short the coil and/or tank for a predetermined time period (e.g., 100 ms). Optionally, the Rx can short the coil and/or tank until a release command is received from the Tx. The time period during which the Rx shorts the receiver side wireless power transfer coil (whether fixed or terminated responsive to a release command received from the Tx) is denoted by block 452 in FIG. 4. Although 100 ms is one exemplary time period, this time period could take on any desired value greater or less than 100 ms, such as 10 ms, 20 ms, 50 ms, 80 ms, 120 ms, 140 ms, 150 ms, 200 ms, etc.

In any case, during the short circuit period, the Tx (e.g., the Tx controller circuitry) can perform the short circuit measurements described above. For example, during block 2.2, a first short circuit measurement can be performed that results in the first short circuit resonant frequency (Fsc1) and optionally the first short circuit resistance Rsc1, which can correspond to a first tuning capacitance value as described above with reference to FIG. 3. Then, at block 2.3, the Tx can change to a different resonant capacitance value, followed by further measurements at block 2.4. More specifically, during block 2.4, a second short circuit measurement can be performed that results in the second short circuit resonant frequency (Fsc2) and optionally the second short circuit resistance Rsc2, which can correspond to a second tuning capacitance value as described above with reference to FIG. 3. Then, in block 2.5, the Rx can open the wireless power receiver coil and/or resonant tank circuit, allowing a further measurement in block 2.6 that results in the second open circuit resonant frequency (Foc2) and optionally the second short circuit resistance Roc2, which can correspond to a second tuning capacitance value as described above with reference to FIG. 3. As noted above, the first open circuit measurements Fsc1 and Fsc2 can be performed in accordance with the startup low power ping of block 1.

Once all of the measurements have been performed, the resulting measurements can be processed by the Tx, e.g., by controller circuitry of the Tx, to determine the (magnetic) coupling coefficient k and, optionally, the resistive coupling coefficient kr in block 2.7, which can proceed as described above with reference to FIG. 3. The timing and sequencing of FIG. 4 is merely one example, and other measurement sequences can be performed in any desired order to determine the particular parameters required in any given application.

In addition to coupling coefficient estimation as described above, in-system measurements can be used to determine other electrical, magnetic, and electromagnetic parameters of a wireless power transfer system (e.g., including a wireless power transmitter PTx and a wireless power receiver PRx). These determined parameters may then be further used for other characterization and control of the wireless power transfer link, including determining stable operating power limits as described in greater detail below.

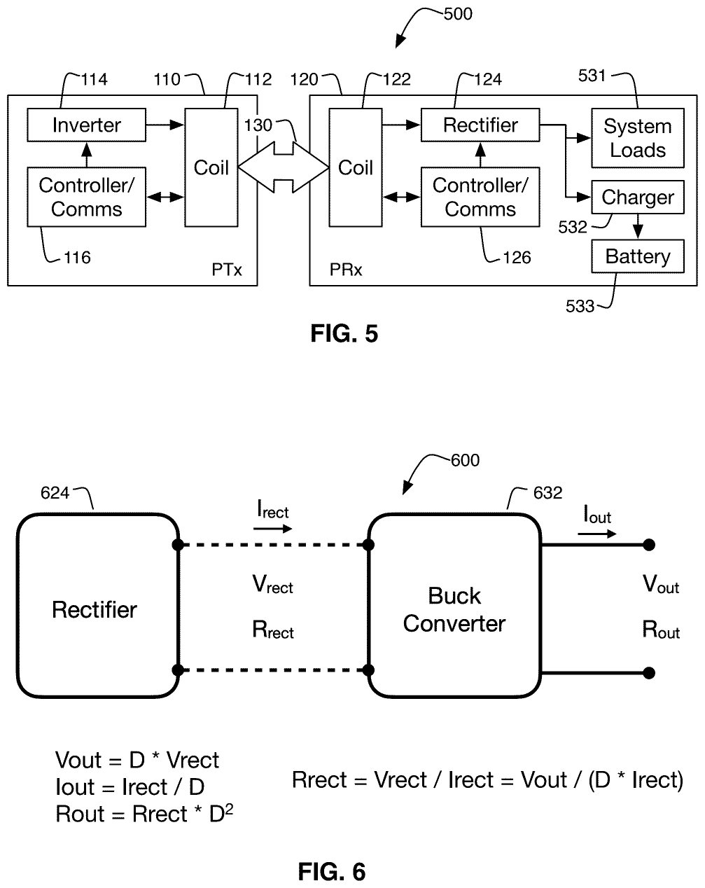

FIG. 5 illustrates a simplified block diagram of a wireless power transfer system 500 depicting loads on the wireless power receiver. Wireless power transfer system 500 can include a wireless power transmitter (PTx) 110, which can be as described above with respect to FIG. 1. For brevity, certain components of PTx 110 have been omitted from FIG. 5, but these and optionally other components may be present in a wireless power transmitter of wireless power transfer system 500. Additionally, wireless power transfer system 500 can include a wireless power receiver (PRx) 120, which can be as described above with respect to FIG. 1. For brevity, certain components of PRx 120 have been omitted from FIG. 5, but these and optionally other components may be present in a wireless power transmitter of wireless power transfer system 500. Additionally, PRx 120 can include system loads 531 that can be powered by the wireless power transfer system. These can include any loads of the device, such as processing systems, display systems, I/O systems, networking or communication systems, etc.

The various systems of the PRx device may also be capable of being powered by a battery 533. The battery can be charged by a charger 532, which can also receive power from the wireless power transfer system to allow for wireless battery charging. Battery charger 532 may be a power converter having any suitable topology. In some embodiments battery charger 532 can be a buck converter that reduces the output voltage of rectifier 124 (Vrect) to a level corresponding to a battery charging target voltage. In other embodiments, battery charger 532 can be a boost converter that increases the output voltage of rectifier 124 (Vrect) to a level corresponding to a battery charging target voltage. In either case, the battery charging target voltage can be determined by a variety of factors such as battery chemistry, number of cells connected in series, state of charge, temperature, etc. Additionally other topologies could be used, such as buck-boost converters, multi-level buck converters, switched capacitor converters, etc., which could operate in either a buck mode or a boost mode depending on the rectifier output voltage (which can also be determined at least in part by the input voltage provided to inverter 114), the battery charging target voltage, etc. As will be described in greater detail below, in a given implementation and configuration the battery charger can be considered as either a buck or step-down converter, meaning that the rectifier output voltage is being reduced to charge the battery, or as a boost or step-up converter, meaning that the rectifier output voltage is being increased to charge the battery.

FIG. 6 illustrates a simplified block diagram 600 of a wireless power receiver rectifier 624 and buck converter battery charger load 632. Rectifier 624 can be a wireless power receiver rectifier like rectifier 124 described above. Battery charger 632 can be used to charge a battery (not shown in FIG. 6) and can be implemented as a buck converter. As described above, the battery charger could also be implemented as a boost converter or other type of converter. Also illustrated in FIG. 6 are various electrical quantities corresponding to the wireless power transfer system and battery charging system as described below. This description relates to the illustrated buck converter embodiment, but similar concepts would apply to a boost converter embodiment or embodiments based on other converter types.

The rectifier output voltage is identified as Vrect. The rectifier output current is identified as Irect. These quantities are also the inputs to buck converter battery charger 632. The resistance Rrect can be defined as Vrect/Irect and represents the load presented to rectifier 624 and thus to the wireless power transfer system. The buck converter battery charger 632 has an output voltage Vout and an output current Iout. There is also a resistance Rout, corresponding to the load on the battery charger, which is Vout/Rout.

Because battery charger 632 is a buck converter (in this example) the output voltage of the battery charger Vout is equal to the rectifier output voltage/buck converter battery charger input voltage Vrect times the duty cycle of the buck converter. In other words, Vout=D*Vrect. Similarly, the output current of the battery charger Iout is equal to the rectifier output current/buck converter battery charger input current Irect divided by the duty cycle of the buck converter. In other words, Iout=Irect/D. As a result, Rout can also be characterized as Rrect*D². These quantities may be referred to in the below discussion. Additionally, these relationships assume that the input power of battery charger 632 is equal to the output power. Although this is not literally true, as the battery charger cannot be 100% efficient, the concepts described herein are not materially affected by this simplifying assumption.

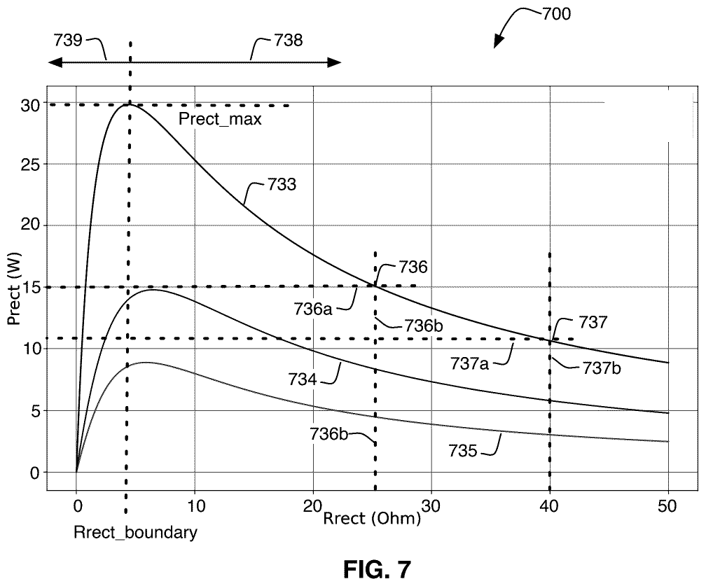

FIG. 7 illustrates a plot 700 exemplary load line curves 733, 734, 735 for a wireless power transfer system. As described above, a wireless power transfer system can include a PTx and a PRx. These devices may be positioned in varying relative positions. Each combination of PTx, PRx, and relative position can be modeled by an equivalent circuit (as in FIG. 2) having different circuit parameters. The result of such an equivalent circuit and a given operating condition, such as input voltages, output voltages, input currents, output currents, etc. can produce a load line. The load line can relate the delivered power, e.g., Prect as plotted on the vertical axis of plot 700 versus load, characterized by resistance Rrect. Each load line, such as example load lines 733, 734, and 735, thus characterizes a wireless power transfer system for a given PTx, a given PRx, a given relative position of PTx and PRx, for a variety of operating conditions or load levels. For example, load line 733 may represent one operating condition. As one example, for a buck type charger load as described above, an operating power of 15 W can correspond to a load resistance (Rrect) of 2502, as represented by operating point 736, which can be traced back to the respective axes by lines 736a and 736b. Similarly, an operating power of 11 W can correspond to a load resistance (Rrect) of 4002, as represented by operating point 737, which can be traced back to the respective axes by lines 737a and 737b

Each load line can have an associated peak, corresponding to a maximum power associated with that configuration and condition of the wireless power transfer system (represented by a maximum Prect value) and a corresponding load resistance (represented by a corresponding Rrect value). For load line 733, the peak corresponds to Prect_max (approximately 30 W) and the corresponding load resistance is Rrect_boundary (approximately 4Ω). To ensure stable operation, buck type chargers should operate on the right side of the peak, depicted by region 738, while boost type chargers should operate on the left side of the peak, depicted by region 739. The peak power value and associated load resistance can thus define a boundary between a stable operation region on the appropriate side of the peak of the load line curve and an unstable operation region on the “wrong” side of the peak of the load line curve. This principle can be used to select a peak power limit for the wireless power transfer system as described below.

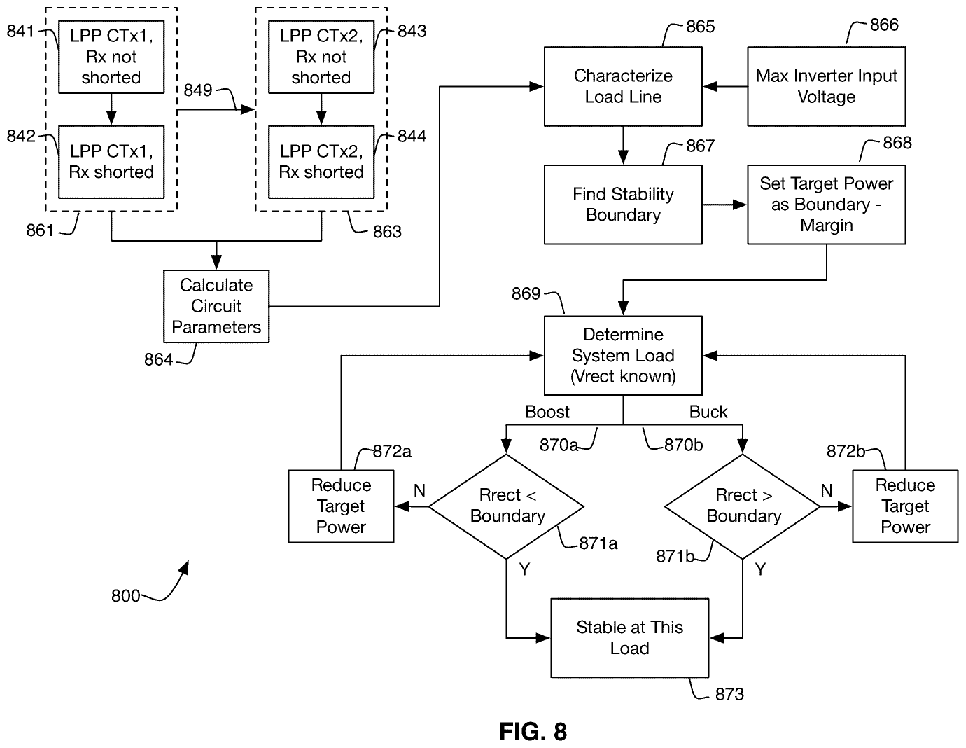

FIG. 8 illustrates a flowchart 800 of a stability and power limit determination technique using in-circuit measurements to determine a stable operating power level. The depicted operations may be performed, for example, by the control and communication circuitry of a wireless power transmitter, such as that described above with reference to FIG. 1. Beginning with blocks 861 and 863, the control circuitry can perform various measurements of circuit conditions for a given PTx, PRx, and relative position configuration with a given transmitter tuning capacitance. In at least some embodiments, these can take the form of low power ping or “LPP” measurements as described in the Qi standards for wireless power transfer promulgated by the Wireless Power Consortium. As was described above with respect FIG. 3 (describing a technique for coupling coefficient determination based on in-circuit or in-system measurements), a first group of measurements 841 may be performed with a first transmitter tuning capacitance CTx1 and the wireless power receiver coil not short circuited, and a second group of measurements 842 may be performed with the same transmitter tuning capacitance but with the wireless power receiver coil short circuited. A third group of measurements 843 may be performed with a second transmitter tuning capacitance CTx2 and the wireless power receiver coil not short circuited, and a fourth group of measurements 844 may be performed with the same transmitter tuning capacitance but with the wireless power receiver coil short circuited. Thus, a transmitter tuning capacitance change 849 may be performed by the wireless power transmitter control circuitry as part of these measurements.

Once all of the measurements have been performed, in block 864, a variety of electrical, magnetic, and electromagnetic circuit parameters may be determined (i.e., calculated or estimated) based on the parameters measured in block 861 and 863. These parameters can include coupling coefficient (k), resistive coupling coefficient (kr), transmitter coil inductance (LTx), receiver coil inductance (LRx), transmitter capacitance (CTx), receiver capacitance (CRx), transmitter system resistance (Rsys_Tx), receiver system resistance (Rsys_Rx), mutual inductance between the transmitter and receiver coils (M), etc. Techniques for determining these parameters from the respective measurements 841-844 described above are known to those skilled in the art and thus are not repeated in detail herein. However, by way of summary, the open circuit and short circuit measurements described above can be used to compute the coupling coefficient k and the resistive coupling coefficient kr as described above with reference to FIG. 3 (see, e.g., discussion of block 348). Additionally, the products (L_{Rx}C_{Rx}) and (R_{Rx}C_{Rx}) can also be determined from the open circuit and short circuit measurements as also described above with reference to FIG. 3 (see, e.g., discussion of block 347).

Then, the value of C_{Rx} can be obtained from the wireless power receiver, e.g., using a low power ping on the receiver. With C_{Rx} known, the values of R_{Rx} and L_{Rx} can be determined by dividing the products described above by the C_{Rx} value. Finally, the mutual inductance can be calculated by:

$$M = k \sqrt{{L}_{Tx} {L}_{Rx}}$$

where k is the coupling coefficient, LTx is the PTx inductance (which is known to the PTx), and LRx is the PRx inductance determined as described above. Similarly, the resistance Rm associated with the wireless power transfer link can be computed by:

$${R}_{m} = kr \sqrt{{R}_{Tx} {R}_{Rx}}$$

where kr is the resistive coupling coefficient, RTx is the equivalent resistance of the PTx, and RRx is the equivalent resistance of the PRx, as described above.

Once the various circuit parameters are determined in block 864, they can be used in block 865 to generate a function that characterizes the load line for the wireless power receiver system in the given configuration. For example, a function of the form:

$${P}_{rect} ( {R}_{rect} ) = \vert {[ {R}_{rect} ( \frac{\frac{\frac{8 {V}_{inv}}{{π}^{2}} ω ( k \sqrt{{L}_{tx} {L}_{rx}} )}{\begin{matrix}{R}_{sys \_ tx} + j ( ω {L}_{tx} - \frac{1}{ω {C}_{tx}} ) + \\ \frac{( - {R}_{m}^{2} + {ω}^{2} {M}^{2} ) - j ( 2 ω {R}_{m} M )}{\begin{matrix}( {R}_{sys \_ rx} + \frac{8}{{π}^{2}} {R}_{rect} ) + j ( ω {L}_{rx} - \frac{1}{ω {C}_{rx}} )\end{matrix}}\end{matrix}}}{( {R}_{sys \_ rx} + \frac{8}{{π}^{2}} {R}_{r e c t} ) + j ( ω {L}_{rx} - \frac{1}{ω {C}_{rx}} )} ) ]}^{2} \vert$$

can be used to compute Prect values for a variety of load resistance values Rrect. Note that this equation depends only on parameters described above, the inverter voltage Vinv (which is known by the PTx control circuitry—block 866) and the values of Rrect being used for the estimation. In some embodiments, this can include a programmable portion of the control circuitry instantiating an array of load resistance values in a memory of the control circuitry and calculating a corresponding array of corresponding power values therefrom that can also be stored in the memory. This combination of arrays represents the load line for the given system. The Rrect values used can be informed by the range of loads expected by the system, which can be a function of the wireless power transfer and battery charging circuitry, battery type and configuration, battery state of charge, etc.

In block 867 a stability boundary can be identified in the load line characterization described above. For example, if arrays of values are used as described above, a maximum value of the calculated Prect values (as a function of Rrect) can correspond to a maximum power level (Prect_max, FIG. 7). The load resistance value Prect_boundary corresponding to the maximum power Prect_max can thus be indicative of the stability boundary as described in greater detail below. In block 868, the target power can be set to a power value corresponding to the identified Prect_max. “Corresponding” in this context means equal or slightly less than, to provide some margin to account for device tolerances, measurement error, etc. For example, the target power may be set to slightly less than Prect_max, e.g., 5%, 10%, 15%, 20%, etc. less than Prect_max. In other cases, the target power may be set to a slight offset from Prect_max, e.g., 1 W, 2 W, 3 W, 5 W, etc. less than Prect_max.

Once an appropriate target power can be set corresponding to the boundary minus an appropriate margin (which occurs in block 868), the system load can be determined in block 869. As one example, this could include determining the system load resistance by dividing the known rectifier output voltage by the load current Irect. For a buck type battery charger (branch 870b), this determined Rrect can be compared to the stability boundary load resistance described above with reference to block 868. If the load resistance is greater than the boundary, as determined in block 871b, then the system can be stable at this load level (block 873). In other words, the system is operating on the right-hand side of the load line curve, as illustrated above with reference to FIG. 7. As a result, wireless power transfer can proceed. Otherwise, for a buck type battery charger (branch 870b), if the computed system load (i.e., load resistance Rrect) is not greater than the identified boundary resistance value, the target power level can be reduced (block 872b). Then, returning to block 869, a new system load at the reduced power can be calculated and used to determine whether the corresponding load resistance Rrect is greater than the determined boundary resistance. This process can be repeated until a stable operating target power level is identified.

Similarly, for a boost type battery charger (branch 870a), the determined Rrect can be compared to the stability boundary load resistance described above with reference to block 868. If the load resistance is less than the boundary, as determined in block 871a, then the system can be stable at this load level (block 873). In other words, the system is operating on the left-hand side of the load line curve, as illustrated above with reference to FIG. 7. As a result, wireless power transfer can proceed. Otherwise, for a boost type battery charger (branch 870a), if the computed system load (i.e., load resistance Rrect) is not less than the identified boundary resistance value, the target power level can be reduced (block 872a). Then, returning to block 869, a new system load at the reduced power can be calculated and used to determine whether the corresponding load resistance Rrect is greater than the determined boundary resistance. This process can be repeated until a stable operating target power level is identified.

In either case, the determined stable power level can be used to maximize the power transfer level for a given wireless power transfer system configuration, including a specific PTx, PRx, and relative positioning of the two, which are characterized by the load line as described above.

Described above are various features and embodiments relating to in-system parameter measurements that can be used to improve operation, control and stability of wireless power transfer systems. Such arrangements may be used in a variety of applications but may be particularly advantageous when used in conjunction with electronic devices such as mobile phones, tablet computers, laptop or notebook computers, and accessories, such as wireless headphones, styluses, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information between the PTx and PRx in the system. The present disclosure contemplates this passage of information improves the devices' ability to provide wireless power signals to each other in an efficient manner to facilitate battery charging, such as by determine the level of inductive coupling between the wireless power transmitter and receiver devices. Entities implementing the present technology should take care to ensure that, to the extent any sensitive information is used in particular implementations, that well-established privacy policies and/or privacy practices are complied with. Such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system and allow users to “opt in” or “opt out” of participation. For instance, such information may be presented to the user when they place a device onto a power transmitter, if the power transmitter is configured to poll for sensitive information from the power receiver.

1. A wireless power transmitter comprising:
an inverter that generates an AC voltage when receiving an input voltage;
a wireless power transmitting coil that receives the AC voltage from the inverter, the wireless power transmitting coil being couplable to a wireless power receiving coil of a wireless power receiver; and
controller circuitry that operates the inverter to deliver power wirelessly, using the wireless power transmitting coil, to the wireless power receiver by:
characterizing a load line corresponding to the wireless power transmitter, the wireless power receiver, and a relative position between the wireless power transmitter and the wireless power receiver using a plurality of wireless power transfer system parameters determined by in-circuit measurements;
identifying a stability boundary associated with the load line; and
operating the wireless power transmitter at a power level that causes the wireless power transmitter to remain on a stable side of the stability boundary for the characterized load line.

2. The wireless power transmitter of claim 1 wherein the plurality of wireless power transfer system parameters determined by in-circuit measurements are determined by combining:
one or more circuit parameters of the wireless power transmitter measured with the wireless power receiving coil effectively short circuited, including one or more circuit parameters measured with a first transmitter tuning capacitance and one or more circuit parameters measured with a second transmitter tuning capacitance, with
one or more circuit parameters of the wireless power transmitter measured with the wireless power receiving coil open circuited, including one or more circuit parameters measured with a first transmitter tuning capacitance and one or more circuit parameters measured with a second transmitter tuning capacitance.

3. The wireless power transmitter of claim 1 wherein identifying a stability boundary associated with the load line comprises identifying a peak power level of the one or more power levels and setting a target power level corresponding to the peak power level.

4. The wireless power transmitter of claim 3 wherein the target power level is the peak power level minus a margin.

5. The wireless power transmitter of claim 4 wherein the margin is selected from the group consisting of: 5%, 10%, 15%, or 20% less the peak power level.

6. The wireless power transmitter of claim 4 wherein the margin is selected from the group consisting of: 1 W, 2 W, 3 W, or 5 W less the peak power level.

7. The wireless power transmitter of claim 3 wherein identifying a stability boundary associated with the load line comprises identifying a boundary resistance associated with the target power level.

8. The wireless power transmitter of claim 7 wherein operating the wireless power transmitter at a power level that causes the wireless power transmitter to remain on a stable side of the stability boundary for the characterized load line comprises:
determining a load resistance applied to the wireless power receiver;
comparing the determined load resistance to the identified boundary resistance; and
responsive to the comparison indicating that the load resistance is not on the stable side of the stability boundary, reducing the target power level.

9. The wireless power transmitter of claim 8 wherein the stable side of the stability boundary is determined at least in part by whether a load on the wireless power receiver is a buck-type converter or a boost-type converter.

10. The wireless power transmitter of claim 9 wherein the load on the wireless power receiver is a battery charger.

11. A method of operating a wireless power transmitter in a wireless power transfer system comprising the wireless power transmitter and a wireless power receiver coupled to the wireless power transmitter, the method being performed by control circuitry of the wireless power transmitter and comprising:
characterizing a load line corresponding to the wireless power transmitter, the wireless power receiver, and a relative position between the wireless power transmitter and the wireless power receiver using a plurality of wireless power transfer system parameters determined by in-circuit measurements;
identifying a stability boundary associated with the load line; and
operating the wireless power transmitter at a power level that causes the wireless power transmitter to remain on a stable side of the stability boundary for the characterized load line.

12. The method of claim 11 wherein the plurality of wireless power transfer system parameters determined by in-circuit measurements are determined by combining:
one or more circuit parameters of the wireless power transmitter measured with the wireless power receiving coil effectively short circuited, including one or more circuit parameters measured with a first transmitter tuning capacitance and one or more circuit parameters measured with a second transmitter tuning capacitance, with
one or more circuit parameters of the wireless power transmitter measured with the wireless power receiving coil open circuited, including one or more circuit parameters measured with a first transmitter tuning capacitance and one or more circuit parameters measured with a second transmitter tuning capacitance.

13. The method of claim 11 wherein identifying a stability boundary associated with the load line comprises identifying a peak power level of the one or more power levels and setting a target power level corresponding to the peak power level.

14. The method of claim 13 wherein the target power level is the peak power level minus a margin.

15. The method of claim 14 wherein the margin is selected from the group consisting of: 5%, 10%, 15%, or 20% less the peak power level.

16. The method of claim 14 wherein the margin is selected from the group consisting of: 1 W, 2 W, 3 W, or 5 W less the peak power level.

17. The method of claim 13 wherein identifying a stability boundary associated with the load line comprises identifying a boundary resistance associated with the target power level.

18. The method of claim 17 wherein operating the wireless power transmitter at a power level that causes the wireless power transmitter to remain on a stable side of the stability boundary for the characterized load line comprises:
determining a load resistance applied to the wireless power receiver;
comparing the determined load resistance to the identified boundary resistance; and
responsive to the comparison indicating that the load resistance is not on the stable side of the stability boundary, reducing the target power level.

19. The method of claim 18 wherein the stable side of the stability boundary is determined at least in part by whether a load on the wireless power receiver is a buck-type converter or a boost-type converter.

20. A wireless power transmitter controller that operates an inverter of the wireless power transmitter to deliver power wirelessly, using a wireless power transmitting coil of the wireless power transmitter, to a wireless power receiver having a wireless power receiving coil couplable to the wireless power transmitting coil, wherein the controller includes circuitry that:
characterizes a load line corresponding to the wireless power transmitter, the wireless power receiver, and a relative position between the wireless power transmitter and the wireless power receiver using a plurality of wireless power transfer system parameters determined by in-circuit measurements;
identifying a stability boundary associated with the load line further comprising:
identifying a peak power level of the one or more power levels;
setting a target power level corresponding to the peak power level; and
identifying a boundary resistance associated with the target power level; and
operating the wireless power transmitter at a power level that causes the wireless power transmitter to remain on a stable side of the stability boundary for the characterized load line further comprising:
determining a load resistance applied to the wireless power receiver;
comparing the determined load resistance to the identified boundary resistance; and
responsive to the comparison indicating that the load resistance is not on the stable side of the stability boundary, reducing the target power level.
